(19) United States
(12) Patent Application Publication
(10) Pub. No.: US 2025/0350618 A1
(43) Pub. Date: Nov. 13, 2025

(54) LOG MANAGEMENT DEVICE, LOG MANAGEMENT SYSTEM, METHOD AND STORAGE MEDIUM THEREOF

(71) Applicant: DENSO CORPORATION, Kariya-city (JP)

(72) Inventors: Naoya ISHIDA, Kariya-city (JP); Masumi EGAWA, Kariya-city (JP); Taiji ABE, Kariya-city (JP); Tomonori IKUSE, Kariya-city (JP); Keita HAYAKAWA, Kariya-city (JP); Keigo NAGARA, Kariya-city (JP)

(21) Appl. No.: 19/189,518

(22) Filed: Apr. 25, 2025

(30) Foreign Application Priority Data
May 7, 2024 (JP) 2024-075471

(51) Int. Cl. H04L 9/40

(52) U.S. Cl. CPC H04L 63/1425

(57) ABSTRACT

A log management device includes a storage unit in which main device information indicating a main log management device is stored. The log management device is configured to: acquire logs from an electronic control unit; determine whether the ego log management device is the main log management device based on the main device information stored in the storage unit of the ego log management device; in response to determining that the ego log management device is the main log management device, transmit the acquired logs to a device located outside of the mobile object; and in response to determining that the ego log management device is not the main log management device, not transmit the acquired logs to the device located outside of the mobile object.

### CROSS REFERENCE TO RELATED APPLICATION

The present application claims the benefit of priority from Japanese Patent Application No. 2024-075471 filed on May 7, 2024. The entire disclosure of the above application is incorporated herein by reference.

### TECHNICAL FIELD

The present disclosure relates to a log management device that manages logs generated by electronic control units mounted on a mobile object, such as an automobile, and transmits the generated logs to an outside device located outside of the mobile object. The present disclosure also relates to a method and program executed by the log management device, and a log management system including the log management device.

### BACKGROUND

In recent years, technologies for driving support and automated driving control, including V2X such as vehicle-to-vehicle communication and road-to-vehicle communication, have been attracting attention. Along with this, vehicles are equipped with communication function, and connectivity of the vehicle is progressing. Since the vehicles are equipped with communication function, the vehicles may receive cyberattacks, and unauthorized access to the vehicles may increase.

### SUMMARY

The present disclosure provides a log management device. The log management device includes a storage unit in which main device information indicating a main log management device is stored. The log management device is configured to: acquire logs from an electronic control unit; determine whether the ego log management device is the main log management device based on the main device information stored in the storage unit of the ego log management device; in response to determining that the ego log management device is the main log management device, transmit the acquired logs to a device located outside of the mobile object; and in response to determining that the ego log management device is not the main log management device, not transmit the acquired logs to the device located outside of the mobile object.

### BRIEF DESCRIPTION OF DRAWINGS

Features of the present disclosure will become apparent from the following detailed description made with reference to the accompanying drawings. In the drawings:

FIG. 1 is an explanatory diagram illustrating an arrangement of a log management device according to each embodiment and a relation of the log management device with related devices;

FIG. 2 is an explanatory diagram for illustrating a configuration example of an electronic control system according to each embodiment;

FIG. 3 is a diagram illustrating a security log generated by a security sensor of an electronic control unit according to each embodiment;

FIG. 4 is a block diagram illustrating a configuration example of the log management device according to a first embodiment;

FIG. 5 is a diagram explaining a correspondence between main device information and master anomaly information according to the first embodiment;

FIG. 6 is a flowchart illustrating an operation of the log management device according to the first embodiment;

FIG. 7 is a flowchart illustrating an operation of the log management device according to the first embodiment;

FIG. 8 is a block diagram illustrating a configuration example of a log management device according to a second embodiment;

FIG. 9 is a flowchart illustrating an operation of the log management device according to the second embodiment;

FIG. 10 is a block diagram illustrating a configuration example of a log management device according to a third embodiment;

FIG. 11 is a diagram illustrating main device information according to the third embodiment;

FIG. 12 is a block diagram illustrating a configuration example of a log management device according to a fourth embodiment; and

FIG. 13 is a diagram explaining main device information according to the fourth embodiment.

### DETAILED DESCRIPTION

The vehicles equipped with communication function may receive cyberattacks, and unauthorized access to the vehicles may increase by the cyberattacks. Thus, it is necessary to analyze the cyberattacks on vehicles and to construct countermeasures against the cyberattacks. The vehicle may transmit information indicating an anomaly occurred in the vehicle to a device located outside the vehicle, and a server device or the like, which has sufficient resource, may analyze a cyberattack based on the received information.

For example, in a related art, a log collection device mounted on a vehicle collects logs from in-vehicle ECUs according to an instruction from a server device and transmits, to the server, aggregated log information generated by aggregating the collected logs. In another related art, an attack detection device mounted on a vehicle acquires log data indicating anomalies occurred in an in-vehicle system and performs an attack determination based on the acquired log data, or transmits a log data set to an attack determination device located outside the vehicle and performs an attack determination outside the vehicle.

The inventors of the present disclosure have found the following difficulties as a result of detailed study.

In the related art, a single log collection device or a single attack determination device mounted on the vehicle collects logs from the in-vehicle system and transmits the collected logs as a data set to a device located outside of the vehicle. When the log collection device is subjected to a cyberattack or has a malfunction, the log collection device may fail to collect the logs properly. When the determination of cyberattack is performed by the log collection device mounted on the vehicle, a reliability of the determination result may be not high enough since the log collection device may fail to accurately detect a cyberattack occurred in the in-vehicle system. Therefore, even when the log collection device is subject to a cyberattack or has a malfunction, proper collection of the logs necessary for cyberattack analysis and determination of cyberattack with high reliability are required for the vehicle.

According to an aspect of the present disclosure, a log management device is provided. The log management device is one of a plurality of log management devices equipped to a mobile object. Each of the plurality of log management devices acquires logs from an electronic control unit. The log management device includes: a log acquisition unit acquiring the logs from the electronic control unit; a storage unit in which main device information is stored, the main device information indicating a main log management device designated from the plurality of log management devices including the ego log management device, the main log management device transmitting the acquired logs to a device located outside of the mobile object; a determination unit determining whether the ego log management device is the main log management device based on the main device information; and a transmission unit transmitting the logs to the device located outside of the mobile object.

When the determination unit determines that the ego log management device is the main log management device, the transmission unit transmits the logs to the device located outside of the mobile object. When the determination unit determines that the ego log management device is not the main log management device, the transmission unit does not transmit the logs to the device located outside of the mobile object.

With the above-described configuration, the log management device can collect, from the electronic control unit, logs necessary for analyzing the cyberattack even when the ego log management device or the different log management device is subjected to a cyberattack. Thus, the log management device according to the present disclosure can perform highly reliable anomaly detection process even when the ego log management device or the different log management devices is subjected to a cyberattack.

The following will describe embodiments of the present disclosure with reference to the accompanying drawings.

In the present disclosure, the configuration disclosed in each embodiment is not limited to each embodiment alone, but may be combined across the embodiments. For example, a configuration disclosed in one embodiment may be combined with another embodiment. The configurations disclosed respectively in multiple embodiments may be collected and combined.

The difficulty described above is not a publicly known difficulty but is originally found by the inventors of the present disclosure, and is a fact that confirms non-obviousness of the present disclosure together with a configuration and a method described in the present disclosure.

### 1. Configuration Common to all Embodiments

(1) Arrangement of Log Management Device and a Relation with Related Device

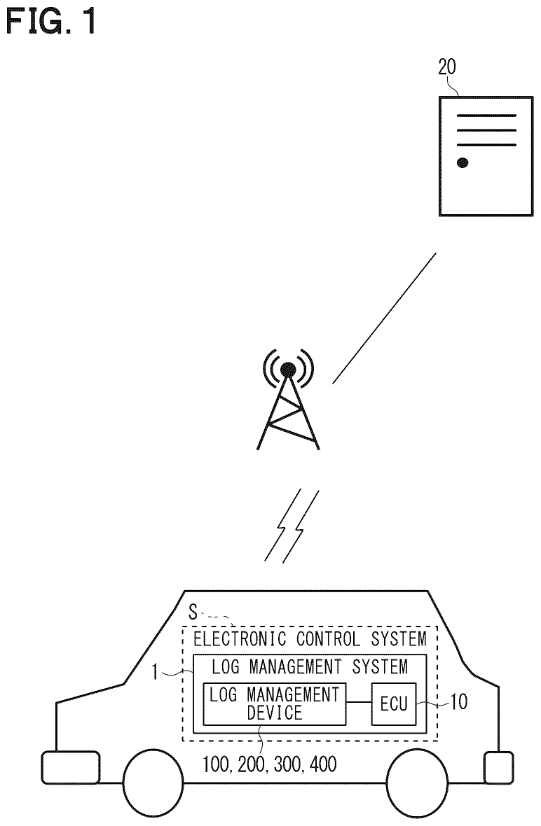

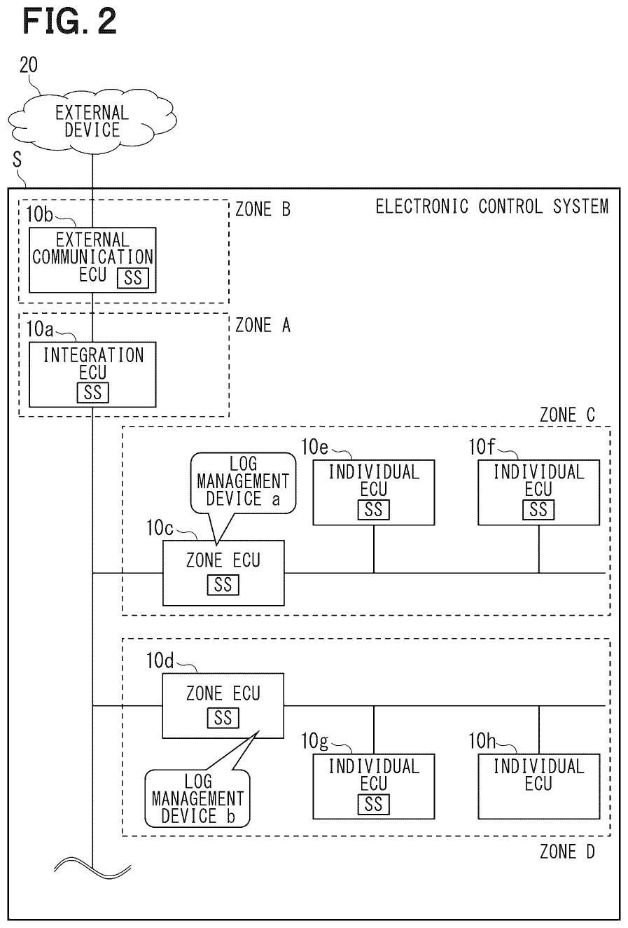

FIG. 1 and FIG. 2 are diagrams showing an arrangement of a log management device and a relation of the log management device with related devices according to each embodiment. As shown in FIG. 1, log management devices 100, 200, 300, and 400 of the respective embodiments are mounted together with an electronic control unit (hereinafter referred to as an ECU) 10 in a vehicle. The vehicle corresponds to a mobile object. Hereinafter, the log management devices 100, 200, 300, and 400 will be collectively referred to as the log management device 100 when it is not necessary to distinguish the log management devices 100, 200, 300, and 400 from one another. The log management device 100 and other components constitute a log management system 1. FIG. 1 illustrates only one log management device 100 and one ECU 10. Alternatively, multiple log management devices 100 and multiple ECUs 10 may be mounted on the mobile object. Details will be described below.

The mobile object refers to a movable object, and a movement speed of the mobile object may be arbitrary. A case where the mobile object is stopped is also included. Examples of the mobile object include, but are not limited to, an automobile, a motorcycle, a bicycle, a pedestrian, a ship, an aircraft, and an object mounted thereon.

The term “mounted” includes not only a case where an object is directly fixed to the mobile object but also a case where an object is moved together with the mobile object although the object is not fixed to the mobile object. Examples of the object include an object carried by a user who is in the mobile object and an object attached to a load carried by the mobile object.

The electronic control unit may be a virtualized electronic control unit implemented using virtualization technology, in addition to a physically independent electronic control unit.

FIG. 1 illustrates an electronic control system S which includes the log management system 1. In each embodiment, the log management device 100 is described as a device provided to multiple ECUs 10 in the electronic control system S. Alternatively, the log management system 1 may be provided outside the electronic control system S, and may be provided as a device separated from the ECU 10.

An external device 20 is located outside the vehicle, and an example of the external device 20 is a Security Operations Center (SOC). The external device 20 uses the security logs transmitted from the log management device 100 to detect and analyze a cyberattack.

In FIG. 1, the electronic control system S and the external device 20 are connected via a communication network using a wireless communication system, such as IEEE 802.11 (Wi-Fi, registered trademark), IEEE 802.16 (WiMAX, registered trademark), wideband code division multiple access (W-CDMA), high speed packet access (HSPA), long term evolution (LTE), long term evolution advanced (LTE-A), 4G, or 5G. Alternatively, dedicated short range communication (DSRC) may be used in the communication between the electronic control system S and the external device 20. When the vehicle is parked in a parking lot or housed in a repair shop, a wired communication may be used instead of the wireless communication. For example, a local area network (LAN), Internet, or a fixed telephone line may be used.

In addition, a communication line combining the wireless communication method and the wired communication method may be used for the communication between the electronic control system S and the external device 20. For example, the electronic control system S and a base station device in a cellular system may be connected by a wireless communication method, such as 4G. The base station device and the external device 20 may be connected by a wired communication method, such as a communication line of a telecommunication carrier or the Internet. A gateway device may be provided at a point of contact between the communication line of the telecommunication carrier and the Internet.

### (2) Configuration of Electronic Control System

FIG. 2 is a diagram showing a configuration example of the electronic control system S. The electronic control system S includes multiple ECUs 10 and an in-vehicle network connecting the multiple ECUs 10. FIG. 2 shows eight ECUs (ECU 10a to ECU 10h) as an example. The electronic control system S may include any number of ECUs. In the following description, the ECUs 10 or each ECU 10 will be used when describing a single or multiple electronic control units as a whole, and the ECU 10a, ECU 10b, ECU 10c, etc. will be used when individually describing specific electronic control unit.

In the case of FIG. 2, the ECUs 10 are connected to one another via an in-vehicle communication network, such as controller area network (CAN) or local interconnect network (LIN). Alternatively, the connection may adopt any wired or wireless communication method, such as Ethernet (registered trademark), Wi-Fi (registered trademark), or Bluetooth (registered trademark).

The term “connection” refers to a state in which data can be exchanged. This state includes a case in which different hardware devices are connected through a wired or wireless communication network, as well as a case in which virtual ECUs (also referred to as virtual machines) running on the same hardware are virtually connected with one another.

The electronic control system S illustrated in FIG. 2 includes an integration ECU 10a, an external communication ECU 10b, zone ECUs 10c, 10d, and individual ECUs 10e, 10f, 10g, 10h.

The electronic control system S includes multiple zones A to D. Each ECU 10 is located in one of the multiple zones. A log management device 100, which is to be described later, is arranged in one of the multiple zones. The electronic control system S is divided into multiple zones, for example, according to the functions of ECUs 10 and the locations where the ECUs 10 are arranged.

The integration ECU 10a is an ECU having a function of controlling the entire electronic control system S and a gateway function for relaying communication among the multiple ECUs 10. The integration ECU 10a may be referred to as a gateway ECU (G-ECU) or a mobility computer (MC). The integration ECU 10a may be a relay device or a gateway device.

The external communication ECU 10b includes a communication unit that communicates with the external device 20 located outside the vehicle. The communication system used by the external communication ECU 10b may be a wireless communication system or a wired communication system as described above.

In order to implement multiple communication systems, multiple external communication ECUs 10b may be provided to the electronic control system S. Instead of providing the external communication ECU 10b, the integration ECU 10a may include the communication function of the external communication ECU 10b.

Each zone ECU 10c, 10d has a gateway function provided according to a function or a location where each individual ECU is arranged. In the example shown in FIG. 2, the zone ECUs 10c, 10d function as gateways in the multiple zones C, D, respectively. For example, the zone ECU 10c has a gateway function of relaying communication between the individual ECU 10e, 10f disposed in a front zone of the vehicle and another ECU 10. The zone ECU 10d has a gateway function of relaying communication between the individual ECU 10g, 10h disposed in a rear zone of the vehicle and another ECU 10.

The individual ECUs 10e, 10f, 10g, 10h can be implemented by ECUs having any function. The ECU may be a drive system electronic control unit that controls an engine, a steering wheel, a brake, etc. The ECU may be a vehicle body electronic control unit that controls a meter, a power window, etc. The ECU may be an information system electronic control unit, such as a navigation device. The ECU may be a safety control electronic control unit that controls the vehicle to prevent a collision with an obstacle or a pedestrian. The ECUs may be classified into a master and a slave instead of parallel arrangement.

In the electronic control system S of FIG. 2, a security sensor is mounted in each ECU 10 except the ECU 10h. The security sensor is abbreviated as SS in the drawing. It is not necessary for the security sensor to be mounted on all of the ECUs 10 constituting the electronic control system S.

The security sensor mounted on each ECU 10 generates a security log in response to detecting an event that occurs in the ECU 10 or in the in-vehicle communication network to which the ECU 10 is connected. The security sensor then transmits the generated security log to the log management device 100. The log management device will be described later. In each embodiment, the log management system 1 includes multiple log management devices 100, and the security sensor transmits the security logs to all of the log management devices 100.

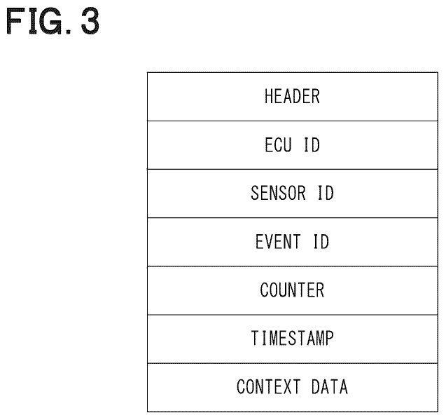

FIG. 3 is a diagram showing a specific example of a security log generated by the security sensor. The security log includes, as fields, an ECU ID indicating identification information of the ECU 10 to which the security sensor is equipped, a sensor ID indicating identification information of the security sensor, an event ID indicating identification information of a security event, a counter indicating occurrence number of the events, timestamp indicating occurrence time of the event, and context data indicating details of an output of the security sensor. The security log may further include a header storing information indicating a protocol version and a state of each data field.

### (3) Log Management Device

The log management system 1 includes multiple log management devices 100. The multiple log management devices 100 all have the same configuration as one another and execute the same process, with the exceptions that will be described in the respective embodiments below. Although FIG. 2 illustrates a configuration example in which the log management system 1 includes two log management devices, the number of log management devices 100 is not limited to two. The log management device 100 is also referred to as an Intrusion Detection System Reporter (IdsR) in the specifications defined by AUTOSAR (AUTomotive Open System ARchitecture).

In the example shown in FIG. 2, the log management devices 100 are provided in the zone ECUs 10c and 10d, respectively. In the following embodiments, the log management device provided in the zone ECU 10c is designated as log management device 100a, 200a, 300a, or 400a, and the log management device provided in the zone ECU 10d is designated as log management device 100b, 200b, 300b, or 400b. The log management devices 100 may be provided in the integration ECU 10a and the external communication ECU 10b in addition to the zone ECUs 10c and 10d. Alternatively, the log management device may be provided in the individual ECU 10e, 10f, 10g, 10h instead of the zone ECUs.

Each of the log management devices 100 is provided in a secure area. The secure area has a resource that is physically or logically separated from a non-secure area. The non-secure area is capable of communicating with an outside device located outside of the vehicle and may be subjected to an attack from outside of the vehicle. The non-secure area can communicate with the outside device located outside of the vehicle. The resource of secure area is separated from that of non-secure area, so that even when the non-secure area is attacked, the secure area is likely to be able to maintain a normal state.

For example, since the external communication ECU 10b has a communication function with the outside of the vehicle, the external communication ECU is highly possible to be subject to a cyberattack from outside of the vehicle. Therefore, when the external communication ECU 10b has a function as the log management device 100, the log management device 100 may also be subject to a cyberattack. Therefore, when the external communication ECU 10b has the function of log management device 100, for example, the external communication ECU 10b may be implemented by an ECU having a hypervisor-type virtual machine, and a virtual machine that functions as the log management device 100 is provided in a secure area, and a virtual machine that functions as an external communication device is provided in a non-secure area. Similarly, when the log management device 100 is provided in an ECU 10 other than the external communication ECU 10b, the log management device 100 may be arranged in the secure area.

### 2. First Embodiment

### (1) Configuration of Log Management Device 100

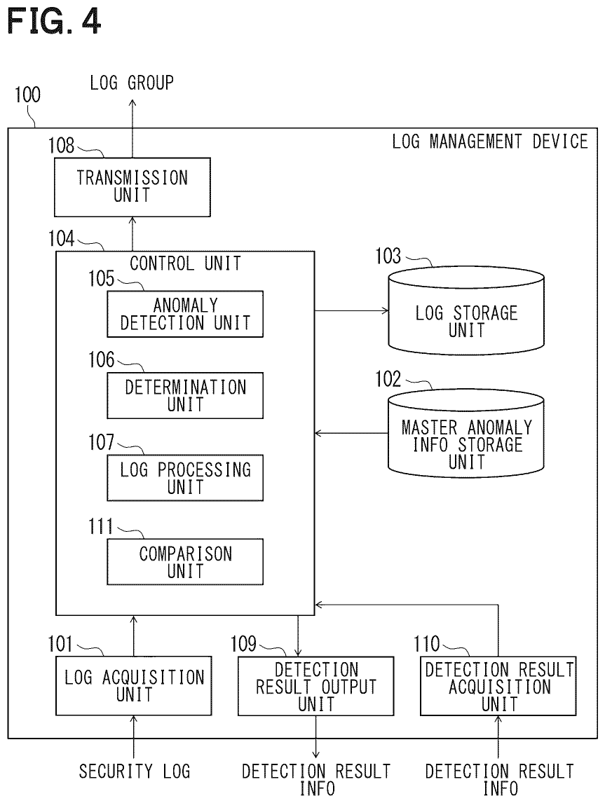

An example of a configuration of the log management device 100 in the present embodiment will be described with reference to FIG. 4. The log management device 100 includes a log acquisition unit 101, a master anomaly information storage unit 102, a log storage unit 103, a control unit 104, a transmission unit 108, a detection result output unit 109, and a detection result acquisition unit 110. The control unit 104 implements functions of an anomaly detection unit 105, a determination unit 106, a log processing unit 107, and a comparison unit 111.

The log acquisition unit 101 acquires security logs (corresponding to logs) generated by the security sensors of the ECUs 10 via the in-vehicle communication network.

The master anomaly information storage unit 102 (corresponding to a storage unit) stores master anomaly information that is used by the anomaly detection unit 105 to detect anomalies from the security logs. In the present embodiment, the master anomaly information storage unit 102 further stores main device information that “indicates” a main log management device among the multiple log management devices 100 in association with the master anomaly information. The main device refers to the log management device 100 that transmits the logs to the external device 20.

The term “indicate” may directly indicate that the device corresponds to the main log management device, or may indirectly indicate that the device corresponds to the main log management device.

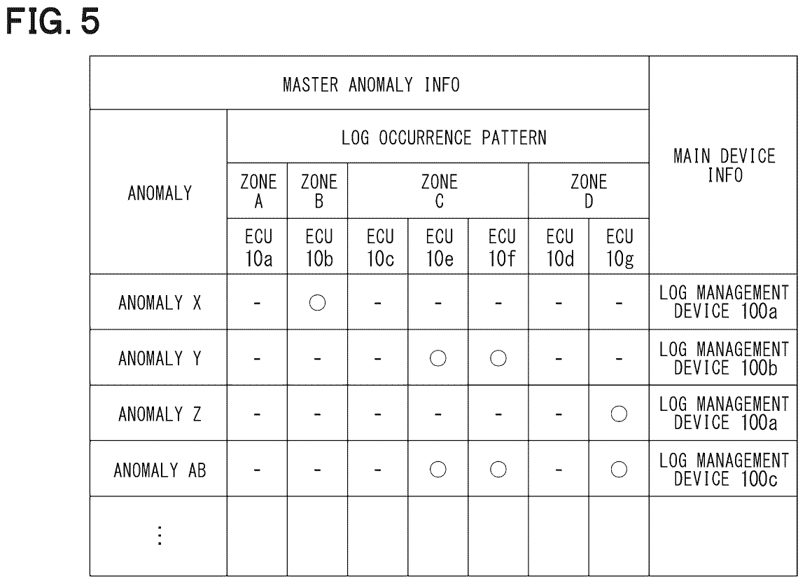

FIG. 5 shows an example of a table indicating a correspondence relation between the main device information and the master anomaly information, which are stored in the master anomaly information storage unit 102 of the present embodiment. In the example shown in FIG. 5, the master anomaly information includes an anomaly predicted to occur in the electronic control system S and a security log pattern that occurs when the anomaly occurs. The security log pattern that occurs when the anomaly occurs is also referred to as a log occurrence pattern.

The master anomaly information in FIG. 5 indicates, for example, that when an anomaly X occurs, a security log is generated by the security sensor equipped to the ECU 10b, and when an anomaly Y occurs, security logs are generated by the security sensors equipped to the ECU 10e and ECU 10f. The master anomaly information may include log occurrence pattern across multiple zones. For example, an anomaly AB shown in FIG. 5 indicates that security logs are generated by the security sensors equipped to the ECUs 10e and 10f included in the zone C and the ECU 10g included in the zone D.

The log occurrence pattern of the master anomaly information shown in FIG. 5 indicates whether a log is generated in each ECU 10. The log occurrence pattern may be a combination of occurrence patterns of specific logs. For example, in ECU 10b, when three types of logs, such as log b1, log b2, and log b3 are possible to be generated as security logs, the master anomaly information may include, for example, a combination of log b1 and log b2 as the log occurrence pattern. In this case, when an anomaly X occurs, security logs b1 and b2 are generated by the security sensor equipped to the ECU 10b.

The main device information associated with the master anomaly information indicates, for example, that when the anomaly X occurs, the log management device 100a operates as the main log management device, and when the anomaly Y occurs, the log management device 100b operates as the main log management device.

The main log management device indicated by the main device information is included in a zone different from the zone in which the ECU 10 in which the anomaly indicated by the master anomaly information is occurred is included. For example, when an anomaly Y occurs, security logs are generated in the ECUs 10e and 10f. Since ECUs 10e and 10f both are included in the zone C, there is a possibility that an anomaly is occurred in the zone C or zone C is under a cyberattack. Therefore, there is a possibility that the log management device 100a installed in the ECU 10c included in the zone C may also have an anomaly or be subject to a cyberattack. Therefore, the reliability of such an anomaly detection result by the log management device 100a is considered to be low, and analysis of logs based on the anomaly detection result, which is output from the log management device 100a to the external device 20, may be not performed. In the example of FIG. 5, the log management device 100b, which is included in the zone D different from the zone C, is shown as the main log management device. As described above, the log management device 100 included in a zone different from the zone in which the ECU 10 having the anomaly occurred is included is set as the main log management device. When the reliability of anomaly detection result generated by one log management device 100 is in doubt, another log management device 100 that has a higher reliability can be used as the main log management device.

As shown in FIG. 4, the log storage unit 103 stores a group of logs generated by the log processing unit 107, which will be described later. Both the master anomaly information storage unit 102 and the log storage unit 103 may be either an external storage device, such as a hard disk, USB memory, CD/BD or the like, or an internal storage device, such as a RAM or the like. The storage device may be a volatile storage device or a nonvolatile storage device. The storage units to be described in each embodiment are implemented in similar manner.

The anomaly detection unit 105 of the control unit 104 detects an anomaly occurred in the ECU 10 based on the security log acquired by the log acquisition unit 101. The anomaly detection unit 105 detects an anomaly using the master anomaly information stored in the master anomaly information storage unit 102. Specifically, the anomaly detection unit 105 detects an anomaly occurred in the ECU 10 by performing a matching process that matches the log occurrence pattern of the master anomaly information, which is stored in the master anomaly information storage unit 102, and a combination of security logs, which is acquired by the log acquisition unit 101.

For example, when the log acquisition unit 101 acquires security logs from the ECU 10e and the ECU 10f within a predetermined duration, the anomaly detection unit 105 detects that an anomaly Y has occurred in the ECU 10.

The anomaly detection unit 105 further generates detection result information, and outputs the detection result information to the determination unit 106. The detection result information indicates an anomaly that is occurred in the ECU 10, for example, anomaly X, anomaly Y, or the like.

As described above, each log management device 100 has the same configuration and performs the same processing. The duration set for the anomaly detection unit 105 to detect an anomaly may be changed depending on the zone in which the ECU 10 that generated the security log is included.

For example, when detecting an anomaly based on a security log (corresponding to a first log) acquired from an ECU 10 that is included in the same zone as the zone in which the log management device 100 is included, the anomaly detection unit 105 detects an anomaly based on one or more security logs acquired within a first duration (for example, 10 seconds) after the log acquisition unit 101 acquires the security log. When detecting an anomaly based on a security log (corresponding to a second log) acquired from an ECU 10 that is included in a different zone from the zone in which the log management device 100 is included, the anomaly detection unit 105 detects an anomaly based on one or more security logs acquired within a second duration (for example, 5 seconds) after the log acquisition unit 101 acquires the security log. The second duration may be set to be shorter than the first duration, that is, the first duration may be set to be longer than the second duration. By setting the first duration to be longer than the second duration as described above, the log management device 100 can perform more detailed anomaly detection for security logs of ECUs 10 included in the same zone compared with the security logs of ECUs 10 included in the different zones.

The determination unit 106 determines, based on the main device information, whether the log management device 100 in which the determination unit 106 is included is the main log management device. Specifically, the determination unit determines whether the log management device 100 is the main log management device based on the main device information, which is associated with the master anomaly information corresponding to the anomaly indicated by the detection result information output from the anomaly detection unit 105. Then, the determination result by the determination unit 106 is output to the log processing unit 107.

The determination based on the main device information indicates determination by referring to the contents of the main device information, and also includes determination based on whether the main device information is stored in the storage unit or not.

For example, according to FIG. 5, when the detection result information indicates an anomaly X, the main device information, which is associated with the master anomaly information to which the anomaly X corresponds, indicates the log management device 100a. Therefore, the determination unit 106 of the log management device 100a determines ego log management device 100a is the main log management device. The determination unit 106 of the log management device 100b determines that ego log management device 100b is not the main log management device.

When the determination result output from the determination unit 106 indicates that the log management device 100 is the main log management device, the log processing unit 107 aggregates, among security logs acquired by the log acquisition unit 101, security logs that are related to anomalies detected by the anomaly detection unit 105. Then, the log processing unit 107 generates a log group using the aggregated security logs, and stores the log group in the log storage unit 103. The security logs related to the anomalies detected by the anomaly detection unit may be logs corresponding to the log occurrence pattern. The security logs related to the anomalies detected by the anomaly detection unit may be logs that do not correspond to the log occurrence pattern, but acquired within a predetermined duration set by the anomaly detection unit 105 to detect the anomaly. In addition to the contents of the logs acquired by the log acquisition unit 101, the log group may further include, for example, a log management device ID indicating the log management device 100 functioning as the main log management device, a table ID indicating the table used by the anomaly detection unit 105 to detect the anomaly, an anomaly ID indicating the anomaly detected by the anomaly detection unit 105, or the like.

When the determination result output from the determination unit 106 indicates that the log management device 100 is not the main log management device, the log processing unit 107 discards the log acquired by the log acquisition unit 101.

The transmission unit 108 outputs the log group stored in the log storage unit 103 to the external device 20. When the log management device 100 is provided in an ECU that does not have a communication function with the external device, the log management device 100 outputs the log group to the external device 20 via the external communication ECU 10b. The transmission unit 108 may output the log group to the external device 20 without storing the log group in the log storage unit 103.

In the present embodiment, the transmission unit 108 transmits the log group to the external device 20 via the wireless communication network immediately after the log group is stored in the log storage unit 103. When the communication condition of the wireless communication network is not good, the log group may be stored in the log storage unit 103 without being transmitted immediately. When the communication condition improves or when the electronic control system S and the external device 20 are connected via wired communication, the transmission unit 108 may transmit the log group to the external device 20. Alternatively, the transmission unit 108 may transmit the log group stored in the log storage unit 103 at the time when the electric power source of vehicle is turned off.

In each embodiment, it is supposed that when the log management device 100 is not the main log management device, the log processing unit 107 does not generate the log group and discards the security logs acquired by the log acquisition unit 101. As another example, when the log management device 100 is not the main log management device, the log processing unit 107 may generate the log group and stores the generated log group in the log storage unit 103. In this case, the generated log group is not transmitted to the external device 20. Since the main log management device transmits the log group to the external device 20, it is necessary to prevent duplicated transmission of the generated log group to the external device 20.

In each embodiment, it is supposed that the anomaly detection unit 105 generates the log group by aggregating security logs used to detect an anomaly, and transmits the generated log group to the external device 20. As another example, even when the anomaly detection unit 105 does not detect an anomaly, the transmission unit 108 may transmit a log group in which security logs are aggregated, to the external device 20. In this case, as in the case of logs related to an anomaly, the main log management device 100 transmits the log group to the external device 20. When no anomaly is detected, the main log management device that transmits the log group is the immediately previous log management device 100 that was determined to be the main log management device. Alternatively, a log management device 100 may be set to be the main log management device by default. When no anomaly is detected for a predetermined duration, the default log management device 100 may operate as the main log management device.

When the determination unit 106 determines that the log management device is not the main log management device, the detection result output unit 109 outputs the detection result information generated by the anomaly detection unit 105 to the log management device 100, which is set as the main log management device.

The detection result acquisition unit 110 acquires the detection result information (corresponding to first detection result information) output from different log management devices 100. As described above, when the log management device 100 determines that ego log management device 100 is not the main log management device, the detection result output unit 109 outputs the detection result information to the main log management device. Therefore, in response to determining that ego log management device 100 is the main log management device, the detection result acquisition unit 110 acquires the detection result information from different log management devices 100.

When the determination unit 106 determines that ego device is the main log management device, the comparison unit 111 compares the detection result information generated by the anomaly detection unit 105 (corresponding to second detection result information) with the detection result information acquired from different log management device 100.

When the detection result information generated by the anomaly detection unit 105 is compared with the detection result information acquired from different log management device 100 and the detection results are different from one another, the transmission unit 108 transmits comparison result information indicating the comparison result to the external device 20 together with the log group. The comparison result information may be transmitted separately from the log group. The comparison result information may include, for example, information indicating that the detection results are different, detection result information of the different log management device 100, identification information of the different log management device 100, or the like.

When the detection results are different from one another as a result of the comparison by the comparison unit 111, there is a high possibility that the different log management device 100 is incapable of detecting an anomaly properly. Therefore, the comparison result is transmitted to the external device 20, and the external device 20 is notified that the different log management device 100 is incapable of detecting an anomaly properly. When the comparison result indicates that the detection results are the same, the transmission unit 108 may transmit, to the external device 20, the comparison result indicating that the detection results are the same.

### (2) Operation of Log Management Device 100

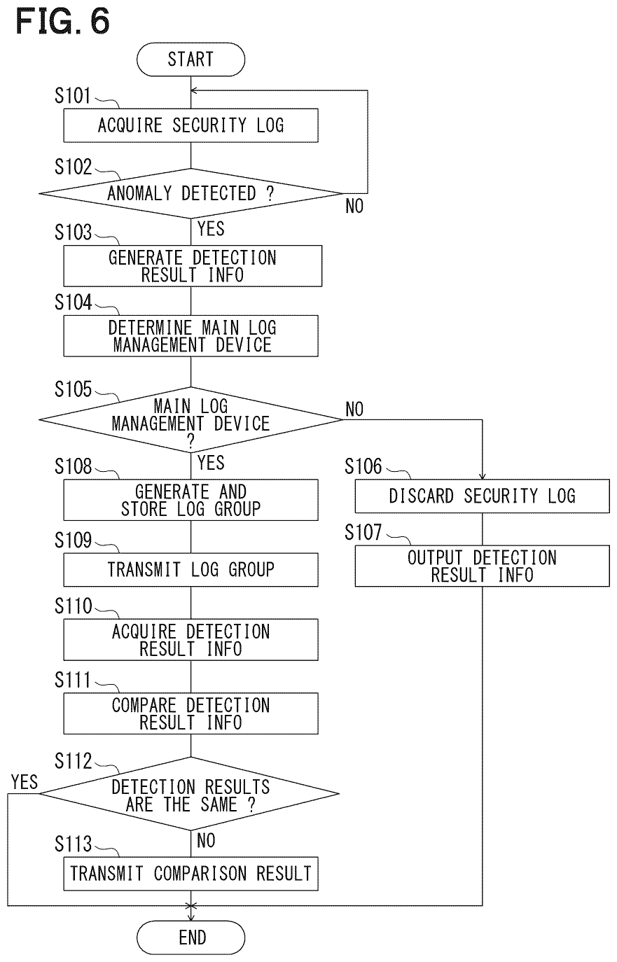

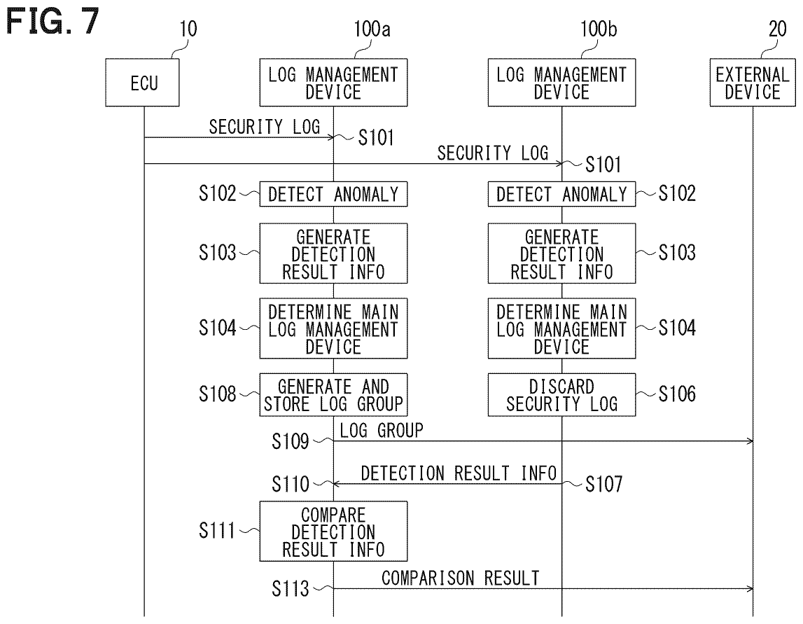

The following will describe an operation of the log management device 100 with reference to FIG. 6 and FIG. 7. FIG. 6 and FIG. 7 show not only a log management method executed by the log management device 100 but also a processing procedure of a log management program executed by the log management device 100. The execution order of process is not limited to that shown in FIG. 6 and FIG. 7. For example, the execution order may be changed unless there are restrictions, such as a relation in which one step uses a result of previous step. The same applies to diagrams showing log management methods of other embodiments to be described below.

FIG. 7 shows an operation of each of the multiple log management devices 100, and illustrates a case where the log management device 100a is the main log management device.

In S101, the log acquisition unit 101 acquires the security log from the security sensor equipped to each ECU 10.

In S102, the anomaly detection unit 105 detects an anomaly that has occurred in the ECU 10 by using the master anomaly information based on the security log acquired in S101.

In S102, when the anomaly detection unit 105 detects an anomaly (S102: Y), the anomaly detection unit 105 generates detection result information in S103.

In S104, the determination unit 106 determines whether ego log management device 100 is the main log management device based on the main device information associated with the master anomaly information corresponding to the anomaly indicated by the detection result information generated in S103.

In S105, in response to determining that ego log management device 100 is not the main log management device (S105: N), the log processing unit 107 discards the security log acquired by the log acquisition unit 101 in S106.

In S107, the detection result output unit 109 outputs the detection result information generated in S103 to the main log management device.

In S105, in response to determining that ego log management device 100 is the main log management device (S105: Y), the log processing unit 107 generates the log group and stores the generated log group in the log storage unit 103 in S108.

In S109, the transmission unit 108 transmits the log group stored in the log storage unit 103 to the external device 20.

In S110, the detection result acquisition unit 110 acquires the detection result information output from the different log management device 100.

In S111, the comparison unit 111 compares the detection result information generated in S103 with the detection result information acquired in S110.

As a comparison result of detection result information in S111, when the detection result information generated in S103 is different from the detection result information acquired in S110 (S112: N), the transmission unit 108 transmits the comparison result to the external device 20 in S113.

### (3) Overview

According to the present embodiment, the log management system includes multiple log management devices and acquires logs from each ECU. Thus, even when one log management device is subject to a cyberattack, the remaining log management device(s) can properly collect logs and transmit the collected logs to the external device.

When one log management device is subject to a cyberattack and the reliability of anomaly detection results of the log management device is in doubt, remaining log management device(s) that is unlikely to be subject to a cyberattack can detect the anomaly and transmit the anomaly detection result to the external device, thereby enabling the anomaly detection function of the log management system as a whole.

### 3. Second Embodiment

In the first embodiment, the detection result detected by the anomaly detection unit 105 is used to determine whether the ego log management device is the main log management device. In the present embodiment, the detection result detected by the anomaly detection unit 105 is not used when determining whether the ego log management device is the main log management device, and details of the present embodiment will be described focusing on differences from the first embodiment.

### (1) Configuration of Log Management Device 200

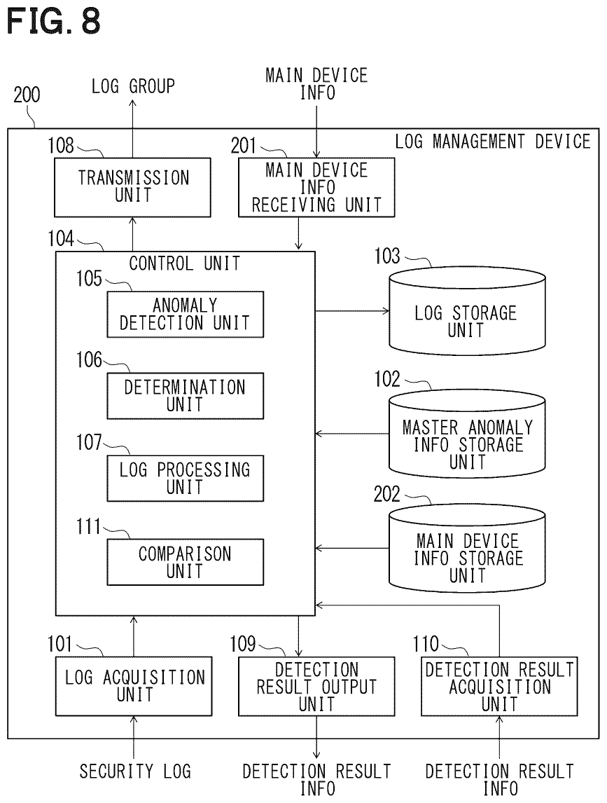

An example of a configuration of the log management device 200 in the present embodiment will be described with reference to FIG. 8. The log management device 200 includes a main device information receiving unit 201 and a main device information storage unit 202, in addition to the components of the log management device 100 of the first embodiment.

The main device information receiving unit 201 (corresponding to a receiving unit) receives main device information from a device other than the ego log management device 200. In the present embodiment, the main device information receiving unit 201 receives the main device information from the external device 20. Instead of the external device 20, the main device information may be received from another device installed in the vehicle.

The main device information storage unit 202 (corresponding to a storage unit) stores the main device information received by the main device information receiving unit 201. In the first embodiment, the main device information is stored in the master anomaly information storage unit 102 in association with the master anomaly information. In the present embodiment, the main device information may be stored without being associated with the master anomaly information. Therefore, in FIG. 8, the master anomaly information storage unit 102 and the main device information storage unit 202 are illustrated as different storage units. Alternatively, as in the first embodiment, the main device information and the master anomaly information may be stored in the same storage unit without separating into two storage units.

The main device information is, for example, information that identifies the log management device 200 set as the main log management device, among the multiple log management devices 200a, 200b, . . . 200n included in the log management system 1. All of the log management devices 200 included in the log management system 1 receive the main device information transmitted from the external device 20. Alternatively, the main device information may be information indicating that the log management device having the main device information is the main log management device. In this case, only the log management device 200 functioning as the main log management device receives the main device information from the external device.

The main device information may directly or indirectly indicate the main log management device. As the main device information indirectly indicating the main log management device, information notifying an occurrence of specific anomaly may be used. In this case, similar to the first embodiment, the master anomaly information and information indicating the main log management device may be stored in associated manner. As an example, master anomaly information indicating a specific anomaly V may be associated with information indicating the main log management device 200a, and stored in the storage unit in associated manner. When the main device information receiving unit 201 receives the main device information notifying the occurrence of anomaly V, the log management device 200a associated with the master anomaly information, which indicates the anomaly V, is identified as the main log management device.

The determination unit 106 of the present embodiment determines whether ego log management device 200 is the main log management device based on the main device information stored in the main device information storage unit 202. When only the log management device 200 operating as the main log management device is configured to receive the main device information, the determination unit 106 may determine whether ego log management device 200 is the main log management device based on whether the main device information is stored in the main device information storage unit 202.

### (2) Operation of Log Management Device 200

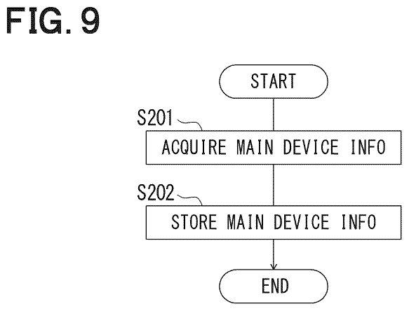

The operation of log management device 200 for acquiring the main device information will be described with reference to FIG. 9.

In S201, the main device information receiving unit 201 acquires the main device information from the external device 20.

In S202, the main device information storage unit 202 stores the main device information acquired in S201.

The process executed by the log management device 200 of the present embodiment after acquiring the security log is basically the same as the operation of log management device 100 of the first embodiment as shown in FIG. 6. In the present embodiment, in determination of the main log management device in S104 by the determination unit 106, the determination unit 106 determines the main log management device based on the main device information acquired in S201.

### (3) External Device 20

In the present embodiment, the external device 20 transmits the main device information to the log management device 200. The external device 20 determines, for example, the log management device 200, which operates as the main log management device, based on the detection and analysis results of a cyberattack, generates the main device information indicating the determined log management device 200 as the main log management device, and transmits the generated main device information to the log management device 200.

For example, the external device 20 may find a vulnerability in the ECU 10 that constitutes the electronic control system S based on a group of logs transmitted from a large number of vehicles. In this case, since the ECU 10 in which the vulnerability is found is at a high risk of being subjected to a cyberattack. When the vulnerable ECU 10 has the function of log management device 200, there is a risk that the log management device 200 may fail to properly detect anomalies if the log management device 200 is used as the main log management device. Therefore, the main device information is generated such that the main device information indicates a different log management device, which is different from the vulnerable ECU 10, that is, the log management device in which the vulnerability is found, as the main log management device. Then, the generated main device information is transmitted to the log management system 1.

In the present embodiment, the external device 20, which is located outside the vehicle, transmits the main device information to the log management device 200. In another example, instead of the external device 20, a device mounted on the vehicle may analyze the cyberattack and transmit the main device information to the log management device 200.

### (4) Overview

In the present embodiment, multiple log management devices determine the main log management device based on the main device information received from devices other than the log management devices.

According to the present embodiment, by determining the main log management device based on the main device information, which is generated based on the analysis results of logs and is transmitted from the external device, it is possible to designate the log management device, which is different from the log management device that is likely to experience a malfunction or be subject to a cyberattack, as the main log management device in advance. Thus, it is possible to prevent a high-risk log management device from being set as the main log management device.

### 4. Third Embodiment

In the present embodiment, the main log management device is determined based on a liveness monitoring log.

The log management device 300 of the present embodiment acquires, from the security sensor equipped to the ECU 10, a liveness monitoring log, in addition to the security log. The liveness monitoring log is generated periodically while the security sensor or the ECU 10 is in operating state, regardless of whether an event is occurred or not. The liveness monitoring log is also referred to as a heartbeat log.

### (1) Configuration of Log Management Device 300

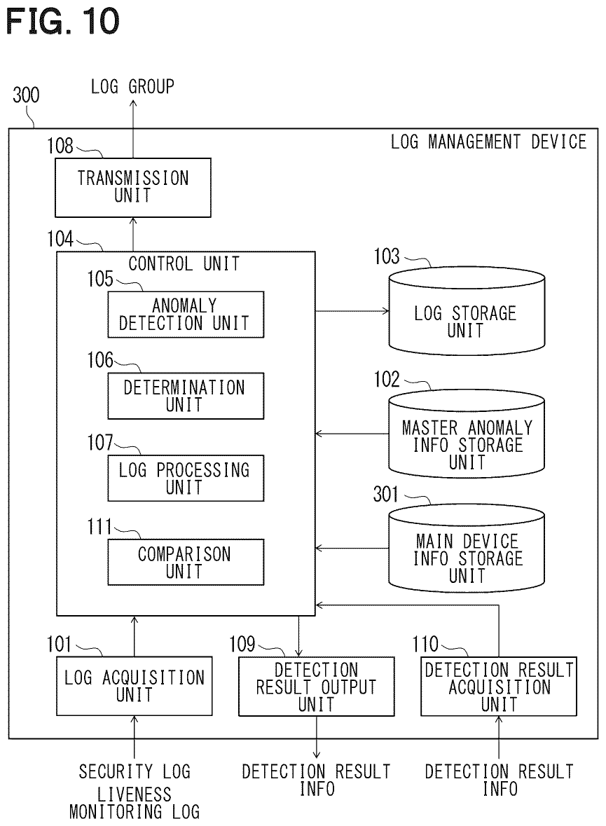

An example of a configuration of the log management device 300 in the present embodiment will be described with reference to FIG. 10.

The log acquisition unit 101 of the present embodiment periodically acquires the liveness monitoring log indicating that the ECU 10 is in operating state, in addition to the security log that is generated in response to the security sensor detecting an event.

A main device information storage unit 301 included in the log management device 300 of the present embodiment stores the main device information, similarly to the second embodiment. The main device information in the present embodiment indicates the main log management device when the ECU 10 included in a specific zone (corresponding to a first zone) among the multiple zones is not in the operating state. Here, the zone in which the main log management device is included is a zone (corresponding to a second zone) different from the specific zone.

When the ECU 10 included in the specific zone is not in the normal operating state, the entire zones may be subject to a cyberattack. The log management device 300 included in the second zone is designated as the main log management device. Here, the second zone is different from the specific zone (also referred to as the first zone) in which the ECU 10, from which the liveness management log is not received, is included. With this configuration, it is possible to prevent the log management device 300, which may be subjected to a cyberattack, from being designated as the main log management device.

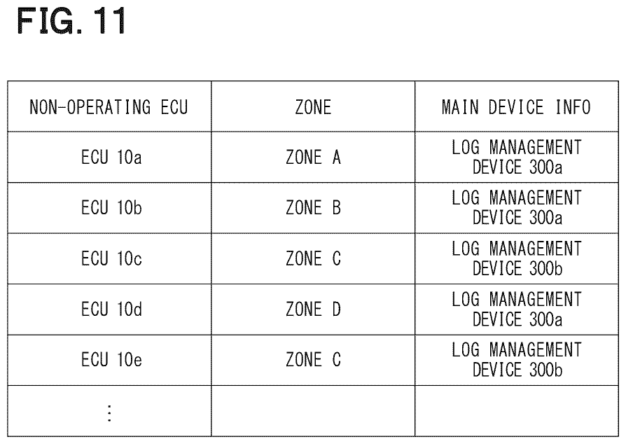

FIG. 11 is a diagram showing an example of the main device information according to the present embodiment. In FIG. 11, the ECU 10 in non-operating state, the zone in which the ECU 10 is included, and the main device information are stored in association with one another. In the example shown in FIG. 11, when the ECUs 10c and 10e included in the zone C are not in the operating states, the main device information indicates that the log management device 300a included in the zone D is designated as the main log management device, but not the log management device 300b included in the zone C. When the ECU 10d included in the zone D is not in the operating state, the main device information indicates that the log management device 300b included in the zone C is designated as the main log management device, but not the log management device 300a included in the zone D. For example, when the log acquisition unit 101 of log management device 300 has not acquired the liveness monitoring log from the ECU 10d included in the zone D, the determination unit 106 of the log management device 300a determines that the log management device 300a is the main log management device, and the determination unit 106 of the log management device 300b determines that the log management device 300b is not the main log management device.

### (2) Operation of Log Management Device 300

The process executed by the log management device 300 of the present embodiment after acquiring the security log is basically the same as the operation of log management device 100 of the first embodiment as shown in FIG. 6. In the present embodiment, in determination of the main log management device in S104 by the determination unit 106, the determination unit 106 determines the main log management device based on the main device information associated with the ECU 10 from which the liveness monitoring log is not received.

### (3) Overview

According to the present embodiment, the log management device included in a zone, which is different from the zone in which the ECU from which the liveness monitoring log is not received is included, is designated as the main log management device, thereby preventing the log management device, which is subjected to a cyberattack, from being designated as the main log management device.

### 5. Fourth Embodiment

In the present embodiment, the main log management device is determined depending on a load status of the log management device.

### (1) Configuration of Log Management Device 400

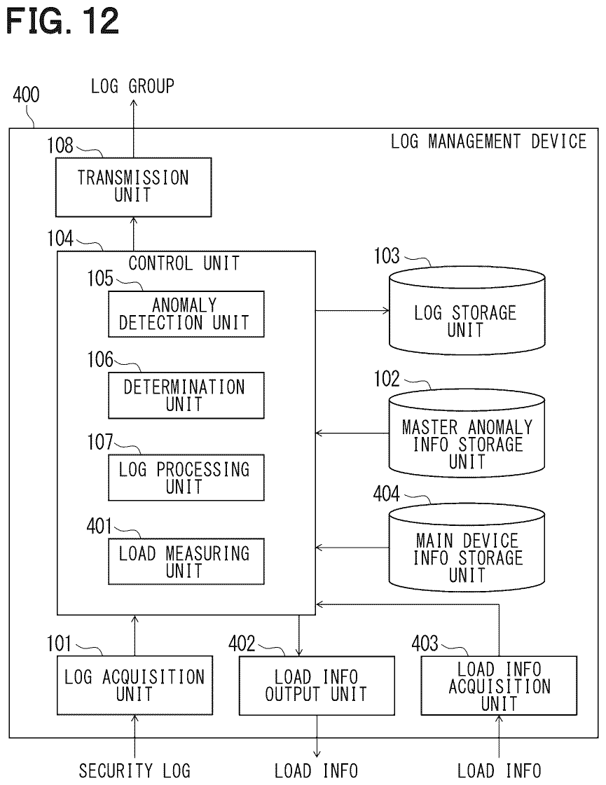

An example of a configuration of the log management device 400 in the present embodiment will be described with reference to FIG. 12. The control unit 104 of the log management device 400 implements a load measuring unit 401. The log management device 400 includes a load information output unit 402 and a load information acquisition unit 403, in addition to the components of the log management device in the first and second embodiments. In FIG. 12, the detection result output unit 109, the detection result acquisition unit 110, and the comparison unit 111 described in the first to third embodiments are omitted. However, similar to the log management devices 100, 200, and 300 of the first to third embodiments, the log management device 400 of the present embodiment may include the detection result output unit 109, the detection result acquisition unit 110, and the comparison unit 111.

The load measuring unit 401 measures the processing load, for example, CPU load in the log management device 400 and a communication load of in-vehicle communication network to which the log management device 400 is connected, and generates load information. The CPU load and the communication load may be collectively referred to as a load of the log management device 400.

The load information output unit 402 outputs the load information generated by the load measuring unit 401 to other log management devices 400.

The load information acquisition unit 403 acquires, from another log management device 400, the load information indicating the load of another log management device 400.

The main device information storage unit 404 of the present embodiment stores the main device information, similarly to the second and third embodiments. The main device information in the present embodiment indicates the main log management device when the load of one of the multiple log management devices 400 included in the log management system 1 is equal to or greater than a predetermined threshold value.

The case of “equal to or greater than” described above includes a case where a first comparison object is the same as a second comparison object, and also includes a case where the first comparison object is not the same as the second comparison object.

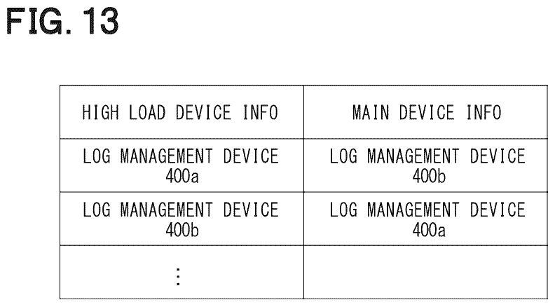

FIG. 13 is a diagram showing an example of main device information according to the present embodiment. In FIG. 13, high-load device information indicating log management device with a load equal to or greater than a predetermined threshold is stored in association with the main device information. Here, the log management device indicated by the high-load device information is different from the log management device indicated by the main device information.

In the example shown in FIG. 13, when the load of log management device 400a is equal to or greater than the predetermined threshold, the log management device 400b is designated as the main log management device. When the load of log management device 400b is equal to or greater than the predetermined threshold, the log management device 400a is designated as the main log management device. Therefore, for example, when the load information acquisition unit 403 of the log management device 400a acquires, from the log management device 400b, the load information indicating a load equal to or greater than the predetermined threshold, the determination unit 106 of the log management device 400a determines that the log management device 400a is the main log management device.

When the load measured by the load measuring unit 401 of ego log management device 400 is equal to or greater than the predetermined threshold, that is, when the load of ego log management device 400 is high, the ego log management device 400 is not designated as the main log management device regardless of the information indicated by the main device information. Therefore, in this case, another log management device 400c (not shown), whose load is lower than the predetermined threshold, is designated as the main log management device. Alternatively, among multiple log management devices 400 whose loads are equal to or greater than the predetermined threshold, the log management device 400 with the lowest load may be designated as the main log management device.

### (2) Operation of Log Management Device 400

The process executed by the log management device 400 of the present embodiment after acquiring the security log is basically the same as the operation of log management device 100 of the first embodiment as shown in FIG. 6. In the present embodiment, in determination of the main log management device in S104 by the determination unit 106, the determination unit determines whether the load indicated by the load information of ego log management device 400 and the load information of another log management devices 400 acquired by the load information acquisition unit 403 is equal to or greater than the predetermined threshold. When the multiple loads are equal to or greater than the predetermined threshold, the determination unit determines the main log management device based on the main device information associated with the log management device whose load is equal to or greater than the predetermined threshold.

### (3) Overview

The main log management device performs processes such as generating logs, transmitting the logs to the external device 20, and comparing the detection results. Thus, the main log management device has a higher processing load than other log management devices. Therefore, when the log management device 400, which has a high processing load, operates as the main log management device, the processing load of the log management device 400 increases further. Therefore, in the present embodiment, when the load of one log management device is equal to or greater than the predetermined threshold, a different log management device other than the log management device with a high load is designated as the main log management device, thereby preventing the load from being concentrated on one log management device.

The features of the log management device or the like in each embodiment of the present disclosure have been described.

Since the terms used in each embodiment are examples, the terms may be replaced with equivalent terms that are synonymous or include synonymous functions.

The block diagram used for the description of each embodiment is obtained by classifying and arranging the configuration of the device by function. The blocks representing the respective functions may be implemented by any combination of hardware or software. Since the blocks represent the functions, such a block diagram may also be understood as disclosures of a method and a program for implementing the method.

The order of the functional blocks that can be understood as the processing, the flow, and the method described in each embodiment may be changed unless there are restrictions, such as a relation in which one step uses the result of another step in the preceding step.

The terms such as first, second, to N-th (where N is an integer) used in each embodiment are used to distinguish two or more configurations and methods of the same kind and are not intended to limit the order or superiority.

Examples of the form of the log analysis device of the present disclosure include the following. Examples of the form of the component include a semiconductor element, an electronic circuit, a module, and a microcomputer. Examples of semi-finished product include an electric control unit (ECU) and a system board. Examples of finished product include a cellular phone, a smartphone, a tablet computer, a personal computer (PC), a workstation, and a server. Other examples of the present disclosure may include a device having communication function, such as a video camera, a still camera, or a car navigation system.

Necessary functions such as an antenna or a communication interface may be appropriately added to the log management device.

The log management device can be implemented not only by dedicated hardware having the configurations and functions described in the embodiments, but also by a combination of a program, which is recorded on a storage medium such as a memory or a hard disk and is used for implementing the above configuration and features, and general-purpose hardware that has a dedicated or general-purpose CPU that can execute the program, a memory, and the like.

A program stored in a non-transitory tangible storage medium (for example, an external storage device (a hard disk, a USB memory, and a CD/BD) of dedicated or general-purpose hardware, or an internal storage device (a RAM, a ROM, and the like)) may also be provided to dedicated or general-purpose hardware via the storage medium or from a server via a communication line without using the storage medium. As a result, it is possible to always provide the latest functions through program upgrade.

The present disclosure is applied to the log management device that manage logs generated by electronic control system mounted on the vehicle. Alternatively, the present disclosure may also be applied to a log management device that manages logs generated by a general-purpose electronic control system that is not mounted on the vehicle.

What is claimed is:

1. A log management device, which is one of a plurality of log management devices equipped to a mobile object, each of the plurality of log management devices acquiring logs from an electronic control unit, the log management device comprising:
a log acquisition unit acquiring the logs from the electronic control unit;
a storage unit in which main device information is stored, the main device information indicating a main log management device designated from the plurality of log management devices including the ego log management device, the main log management device transmitting the acquired logs to a device located outside of the mobile object;
a determination unit determining whether the ego log management device is the main log management device based on the main device information; and
a transmission unit transmitting the logs to the device located outside of the mobile object,
wherein,
when the determination unit determines that the ego log management device is the main log management device, the transmission unit transmits the logs to the device located outside of the mobile object, and
when the determination unit determines that the ego log management device is not the main log management device, the transmission unit does not transmit the logs to the device located outside of the mobile object.

2. The log management device according to claim 1, further comprising
an anomaly detection unit detecting an anomaly occurred in the electronic control unit based on the logs and generating detection result information,
wherein the transmission unit transmits the logs related to the detected anomaly.

3. The log management device according to claim 2, wherein
the storage unit stores the main device information in association with master anomaly information indicating an anomaly predicted to occur in the electronic control unit, and
the determination unit determines whether the ego log management device is the main log management device based on the main device information associated with the master anomaly information corresponding to the anomaly indicated by the detection result information.

4. The log management device according to claim 3, wherein
the mobile object is equipped with an electronic control system,
the electronic control system includes multiple electronic control units that are distributed into multiple zones according to functions or locations of the multiple electronic control units,
each of the multiple zones includes one or more of the plurality of log management devices, and
the main log management device indicated by the main device information is included in one of the multiple zones different from another one of the multiple zones in which the electronic control unit having the anomaly is included.

5. The log management device according to claim 2, further comprising
a detection result output unit outputting the detection result information to the main log management device indicated by the main device information in response to the determination unit determining that the ego log management device is not the main log management device.

6. The log management device according to claim 5, further comprising
a detection result acquisition unit acquiring, in response to the determination unit determining that the ego log management device is the main log management device, the detection result information generated by a different log management device as first detection result information from the different log management device, the different log management device being one of the plurality of log management devices; and
a comparison unit comparing the acquired first detection result information with second detection result information, the second detection result information being the detection result information generated by the anomaly detection unit of the ego log management device,
wherein,
when the first detection result information is different from the second detection result information as a comparison result determined by the comparison unit, the transmission unit transmits comparison result information indicating the comparison result determined by the comparison unit to the device located outside of the mobile object.

7. The log management device according to claim 1, further comprising
a receiving unit receiving the main device information,
wherein the storage unit stores the main device information received by the receiving unit.

8. The log management device according to claim 1, wherein
the mobile object is equipped with an electronic control system,
the electronic control system includes multiple electronic control units that are distributed into multiple zones according to functions or locations of the multiple electronic control units,
each of the multiple zones includes one or more of the plurality of log management devices,
the log acquisition unit periodically acquires a liveness monitoring log from one of the multiple electronic control units,
when one of the multiple electronic control units included in a first zone among the multiple zones is not in an operating state, the log management device included in a second zone different from the first zone is designated as the main log management device by the main device information, and
when the log acquisition unit fails to acquire the liveness monitoring log from one of the multiple electronic control units, the determination unit determines whether the ego log management device is the main log management device based on the main device information.

9. The log management device according to claim 1, further comprising
a load information acquisition unit acquiring load information indicating a load of a different log management device from the different log management device,
wherein
the different log management device is one of the plurality of log management devices,
the main device information indicates the main log management device designated in a case where a load of one of the plurality of log management devices is equal to or greater than a predetermined threshold, and
when the load indicated by the acquired load information is equal to or greater than the predetermined threshold, the determination unit determines whether the ego log management device is the main log management device based on the main device information.

10. The log management device according to claim 9, further comprising
a load measuring unit measuring a load of the ego log management device,
wherein, when the load of the ego log management device measured by the load measuring unit is equal to or greater than the predetermined threshold, the determination unit determines that the ego log management device is not the main log management device regardless of the main device information.

11. The log management device according to claim 1, wherein
the transmission unit transmits the logs via a communication device that communicates with the device located outside of the mobile object,
the log management device is provided in a secure area, and
the communication device is located in a non-secure area.

12. The log management device according to claim 4, wherein,
when the electronic control unit and the log management device are included in a same zone among the multiple zones, the log acquired from the electronic control unit is defined as a first log,
the anomaly detection unit detects the anomaly based on one or more logs acquired within a first duration after the log acquisition unit acquired the first log,
when the electronic control unit and the log management device are included in different zones among the multiple zones, the log acquired from the electronic control unit is defined as a second log,
the anomaly detection unit detects the anomaly based on one or more logs acquired within a second duration after the log acquisition unit acquired the second log, and
the second duration is set to be shorter than the first duration.

13. A log management method executed by a log management device, wherein the log management device is one of a plurality of log management devices equipped to a mobile object, the log management device includes a storage unit in which main device information is stored, and the main device information indicates a main log management device which is designated from the plurality of log management devices, the log management method comprising:
acquiring logs from an electronic control unit;
determining whether the ego log management device is the main log management device based on the main device information stored in the storage unit of the ego log management device;
in response to determining that the ego log management device is the main log management device, transmitting the acquired logs to a device located outside of the mobile object; and
in response to determining that the ego log management device is not the main log management device, not transmitting the acquired logs to the device located outside of the mobile object.

14. A computer-readable non-transitory storage medium storing a log management program, the log management program comprising instructions to be executed by at least one processor of a log management device, wherein the log management device is one of a plurality of log management devices equipped to a mobile object, the log management device includes a storage unit in which main device information is stored, and the main device information indicates a main log management device which is designated from the plurality of log management devices, the instructions of the log management program comprising:
acquiring logs from an electronic control unit;
determining whether the ego log management device is the main log management device based on the main device information stored in the storage unit of the ego log management device;
in response to determining that the ego log management device is the main log management device, transmitting the acquired logs to a device located outside of the mobile object; and
in response to determining that the ego log management device is not the main log management device, not transmitting the acquired logs to the device located outside of the mobile object.

15. A log management system equipped to a mobile object, the log management system comprising:
a first log management device acquiring logs from an electronic control unit; and
a second log management device acquiring the logs from the electronic control unit,
wherein
the first log management device includes:
a first log acquisition unit acquiring the logs from the electronic control unit;
a first storage unit in which main device information is stored, the main device information indicating a main log management device which is designated from the first and second log management devices included in the log management system, the main log management device transmitting the acquired logs to a device located outside of the mobile object; and
a first determination unit determining that the first log management device is not the main log management device based on the main device information, and
the second log management device includes:
a second log acquisition unit acquiring the logs from the electronic control unit;
a second storage unit in which the main device information indicating the main log management device is stored;
a second determination unit determining that the second log management device is the main log management device based on the main device information; and
a transmission unit transmitting the logs to the device located outside of the mobile object.

16. A log management method executed by a log management system equipped to a mobile object, wherein the log management system includes a first log management device and a second log management device each acquiring logs from an electronic control unit, each of the first and second log management devices includes a storage unit in which main device information is stored, the main device information indicating a main log management device which is designated from the first and second log management devices included in the log management system, the log management method comprising:
acquiring, by the first log management device, the logs from the electronic control unit;
determining, in the first log management device, that the first log management device is not the main log management device based on the main device information stored in the storage unit of the first log management device;
acquiring, by the second log management device, the logs from the electronic control unit;
determining, in the second log management device, that the second log management device is the main log management device based on the main device information stored in the storge unit of the second log management device; and
transmitting, by the second log management device, the acquired logs to a device located outside of the mobile object.
